(19) United States
(12) Patent Application Publication
(10) Pub. No.: US 2026/0366199 A1
(43) Pub. Date: Nov. 19, 2026

(54) FILAMENT FOR FISHERY MATERIAL

(71) Applicant: KUREHA CORPORATION, Tokyo (JP)

(72) Inventors: Takashi MASAKI, Tokyo (JP); Fuminori KOBAYASHI, Tokyo (JP); Haruki MOKUDAI, Tokyo (JP)

(73) Assignee: KUREHA CORPORATION, Tokyo (JP)

(21) Appl. No.: 19/108,046

(22) PCT Filed: Sep. 29, 2023
(86) PCT No.: PCT/JP2023/035643

§ 371 Date: Feb. 28, 2025

(30) Foreign Application Priority Data
Sep. 30, 2022 (JP) 2022-158909
Apr. 28, 2023 (JP) 2023-074576

(51) Int. Cl. D01F 6/80; A01K 75/00; A01K 91/00; C08G 69/24

(52) U.S. Cl. CPC D01F 6/80; A01K 75/005; A01K 91/00; C08G 69/24; D10B 2401/063; D10B 2507/00; D10B 2507/02

(57) ABSTRACT

A filament for a fishery material made of nylon, the filament having biodegradability and adequate knot strength in water and being less likely to generate a filament containing a monomer that has decomposed in melt processing. The filament for a fishery material includes a filament containing a nylon resin having a structural unit represented by Formula (1) and a structural unit of another nylon, and the nylon resin has a proportion of the structural unit represented by Formula (1) of 1 mol % or greater and less than 40 mol % with respect to all structural units. In Formula (1), x is an integer of 3.

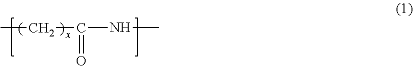

### TECHNICAL FIELD

The present invention relates to a filament for a fishery material.

### BACKGROUND ART

Typically, a fishing line contains a monofilament of polyethylene, nylon, fluorocarbon, or the like. Among these, nylon can be applied for various fishing forms because nylon has both flexibility and proper elongation properties as well as high knot strength.

Research and development have been conducted to enhance properties of nylon for a fishing line. For example, Patent Document 1 describes that a fishing line produced using a resin composition containing a copolymer of nylon 6 and nylon 66 (nylon 6/66) and a polyarylate can enhance smoothness of a surface to allow the fishing line to move forward and backward smoothly through guides of a fishing rod while ease in elongation is adjusted. Furthermore, Patent Document 2 describes that a fishing line suitable for white crucian carp fishing is produced by adjusting the blending ratio of nylon 6 and nylon 6/66.

### CITATION LIST

### Patent Document

Patent Document 1: JP 2006-122005 A
Patent Document 2: JP 2011-101618 A

### SUMMARY OF INVENTION

### Technical Problem

As described in Patent Document 1, Patent Document 2, and the like, various fishing lines of nylons have been developed and used in various fishing purposes. However, because nylon 6 and nylon 6/66 are not biodegradable resins, there are issues of environmental pollution due to cut fishing lines and issues of ghost gear trapping marine organisms.

On the other hand, it is also considered that the issues described above can be solved by using a biodegradable nylon such as nylon 4. However, nylon 4 readily absorb moisture in water and has an issue that knot strength in water tends to decrease. Furthermore, because nylon 4 is thermally decomposed readily, a monomer generated by decomposition during melt processing tends to be mixed in a filament, and elution of this decomposed monomer may cause environmental pollution. Note that similar problems occur in fishing nets and the like that may use nylon filaments, similarly.

The present invention is competed in light of the problems described above, and an object of the present invention is to provide a filament for a fishery material made of nylon, the filament having biodegradability and adequate knot strength in water, and having a reduced mixed amount of monomers in a filament by suppressing decomposition during melt processing.

### Solution to Problem

Embodiments of the present invention to solve the problems described above relates to filaments for fishery materials of [1] to [9] described below.

[1] A filament for a fishery material, including:
a filament containing a nylon resin including a structural unit represented by the following Formula (1) and a structural unit of another nylon,
wherein the nylon resin has a proportion of the structural unit represented by the following Formula (1) with respect to all structural units of 1 mol % or greater and less than 40 mol %.

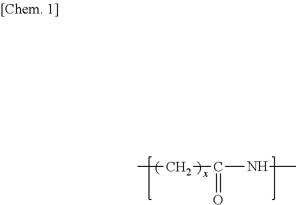

In Formula (1), x is an integer of 1 or greater and 3 or less.

[2] The filament for a fishery material according to [1], wherein the nylon resin is a random copolymer in which the structural unit represented by Formula (1) and the structural unit of the other nylon are randomly arranged.

[3] The filament for a fishery material according to [1] or [2], wherein the structural unit represented by Formula (1) includes a structural unit where x is 3.

[4] The filament for a fishery material according to any of [1] to [3], wherein the structural unit of the other nylon include a nylon 6 structural unit or a nylon 12 structural unit.

[5] The filament for a fishery material according to any of [1] to [4], wherein a knot strength measured at 25 °C and a relative humidity of 50% is 300 MPa or greater.

[6] The filament for a fishery material according to any of [1] to [5], wherein a knot strength measured at 25 °C after the filament is knotted and immersed in pure water at 25 °C for 3 hours, and then taken out from the pure water without drying is 100 MPa or greater.

[7] The filament for a fishery material according to any of [1] to [6], wherein a reduction percentage of a knot strength measured at 25 °C and a relative humidity of 50% after the filament is stored in an interface between sea water and sediment at 25 °C for 1 month and washed with water then dried, with respect to a knot strength measured in the same conditions before the storage, is 10% or greater.

[8] The filament for a fishery material according to any of [1] to [7], which is a fishing line.

[9] The filament for a fishery material according to any of [1] to [7], which is a fishing net.

### Advantageous Effects of Invention

According to an embodiment of the present invention, a filament for a fishery material made of nylon, the filament having biodegradability and adequate knot strength in water and having a reduced mixed amount of monomers in a filament by suppressing decomposition during melt processing, is provided.

### DESCRIPTION OF EMBODIMENTS

An embodiment of the present invention relates to a filament for a fishery material containing a nylon resin.

### Nylon Resin

The nylon resin described above includes a structural unit represented by the following Formula (1) and a structural unit of another nylon. The nylon resin described above has a proportion of the structural unit represented by the following Formula (1) with respect to all structural units of 1 mol % or greater and less than 40 mol %.

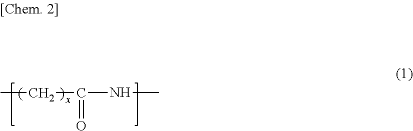

In Formula (1), x is an integer of 1 or greater and 3 or less. Note that, when x is 2 or 3, the alkylene group in Formula (1) may be linear or branched.

The structural unit represented by Formula (1) may include only structural units having the same number for x or may include a plurality of types of structural units having different numbers for x.

The nylon resin described above is a copolymer including a structural unit represented by Formula (1) and another nylon structural unit. The structural unit represented by Formula (1) imparts biodegradability to the filament while the proportion of the structural unit represented by Formula (1) is set to a predetermined range, and thus reduction in strength of the filament due to water absorption is suppressed, and knot strength in water is enhanced. As a result of these effects, it is assumed that the filament containing the nylon described above has both biodegradability and adequate knot strength in water.

From the viewpoint of achieving a good balance between the biodegradability described above and knot strength in water, the nylon resin described above has a proportion of the structural unit represented by the following Formula (1) with respect to all structural units of 1 mol % or greater and less than 40 mol %. A larger proportion of the structural unit represented by Formula (1) tends to make biodegradability of the filament better, and a larger proportion of the structural unit of another nylon tends to increase knot strength in water. From the viewpoint of achieving both in a compatible manner, the nylon resin described above has a proportion of the structural unit represented by Formula (1) with respect to all the structural units of preferably 3 mol % or greater and 35 mol % or less, more preferably 5 mol % or greater and 20 mol % or less, even more preferably 5 mol % or greater and 17 mol % or less, and particularly preferably 5 mol % or greater and 14 mol % or less.

Furthermore, from the same viewpoint, the nylon resin described above has a proportion of the structural unit of the other nylon with respect to all the structural units of preferably greater than 60 mol % and 99 mol % or less, more preferably 65 mol % or greater and 97 mol % or less, even more preferably 80 mol % or greater and 95 mol % or less, yet even more preferably 83 mol % or greater and 95 mol % or less, and particularly preferably 86 mol % or greater and 95 mol % or less.

The structural unit represented by Formula (1) may be a structural unit having x=1 and derived from glycine (hereinafter, also referred to as “NA2 structural unit”), may be a structural unit having x=2 and derived from α-alanine (2-aminopropanoic acid), β-alanine (3-aminopropanoic acid), or β-lactam (2-azetidinone) (hereinafter, also referred to as “NA3 structural unit”), or may be a structural unit having x=3 and derived from γ-aminobutyric acid or 2-pyrrolidone (hereinafter, also referred to as “NA4 structural unit”).

The structural unit of the other nylon may be a structural unit represented by Formula (2) made by ring-opening polymerization of a lactam compound or polymerization of amino acid, or may be a structural unit represented by Formula (3) and a structural unit represented by Formula (4) respectively derived from the diamine described above and the dicarboxylic acid described above when the moieties formed by condensation of a polyamine and a polycarboxylic acid are contained in the nylon resin described above. The structural unit of the other nylon may contain only one of these or may contain a plurality of these.

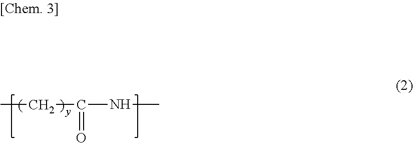

In Formula (2), y is an integer of 4 or greater and 11 or less. Note that the alkylene group in Formula (2) may be linear or branched.

When the structural unit represented by Formula (2) is contained, the structural unit of the other nylon may include only structural units having the same number for y or may include a plurality of types of structural units having different numbers for y.

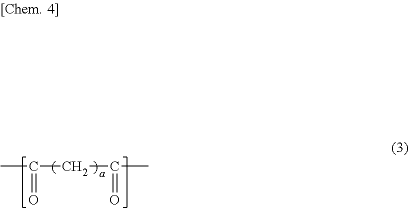

In Formula (3), a is an integer of 1 or greater and 10 or less. Note that the alkylene group in Formula (3) may be linear or branched.

When the structural unit represented by Formula (3) is contained, the structural unit of the other nylon may include only structural units having the same number for a or may include a plurality of types of structural units having different numbers for a.

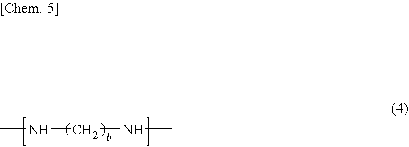

In Formula (4), b is an integer of 1 or greater and 12 or less. Note that the alkylene group in Formula (4) may be linear or branched.

When the structural unit represented by Formula (4) is contained, the structural unit of the other nylon may include only structural units having the same number for b or may include a plurality of types of structural units having different numbers for b.

From the viewpoint of enhancing biodegradability of a molded body, the structural unit of the other nylon preferably includes a structural unit represented by Formula (2), in which x is 4 or greater and 7 or less, and more preferably includes a structural unit, in which y is 5, (hereinafter, also referred to as “NA 6 structural unit”), and even more preferably, the structural unit represented by Formula (1) is a NA4 structural unit having x=3 and the structural unit of the other nylon is a NA6 structural unit having y=5. The proportion of the NA 6 structural unit with respect to the structural unit of the other nylon is preferably 50 mol % or greater and 100 mol % or less, more preferably 70 mol % or greater and 100 mol % or less, and even more preferably 85 mol % or greater and 100 mol % or less.

Alternatively, from the viewpoint of enhancing water resistance of a molded body, the structural unit of the other nylon preferably includes a structural unit represented by Formula (2), in which y is 8 or greater and 11 or less, and more preferably includes a structural unit, in which y is 11, (hereinafter, also referred to as “NA 12 structural unit”), and even more preferably, the structural unit represented by Formula (1) is a NA4 structural unit having x=3 and the structural unit of the other nylon is a NA 12 structural unit having y=11. The proportion of the NA 12 structural unit with respect to the structural unit of the other nylon is preferably 50 mol % or greater and 100 mol % or less, more preferably 70 mol % or greater and 100 mol % or less, and even more preferably 85 mol % or greater and 100 mol % or less.

The structural units derived from the diamine described above and the dicarboxylic acid described above can be respectively, for example, structural units derived from the following diamine and the following dicarboxylic acid when the nylon resin described above contains a moiety formed by condensation of a diamine, such as hexamethylenediamine, nonanediamine, methylpentadiamine, m-xylylenediamine, p-phenylenediamine, and m-phenylenediamine, and a dicarboxylic acid, such as adipic acid, sebacic acid, terephthalic acid, and isophthalic acid. At this time, it is preferable that the structural unit represented by Formula (1) is a NA4 structural unit having x=3 and the structural unit of the other nylon is a structural unit represented by Formula (3), in which a=4, and a structural unit represented by Formula (4), in which b=6, which are formed by condensation of hexamethylenediamine and adipic acid, from the viewpoint of enhancing heat resistance of a molded body, the nylon resin described above has a proportion of the structural units derived from the diamine described above and the dicarboxylic acid described above with respect to all the structural units of preferably 50 mol % or greater and 100 mol % or less, more preferably 70 mol % or greater and 100 mol % or less, and even more preferably 85 mol % or greater and 100 mol % or less.

The nylon resin described above may be a copolymer consisting only of the structural unit represented by Formula (1) and the structural unit of the other nylon or may be a copolymer further containing another structural unit. Examples of such another structural unit described above include a structural unit derived from a polymerization initiator and a structural unit other than nylon. From the viewpoint of enhancing biodegradability, the nylon resin described above has a proportion of such another structural unit described above with respect to all the structural units of preferably 0 mol % or greater and 50 mol % or less, more preferably 0 mol % or greater and 30 mol % or less, and even more preferably 0 mol % or greater and 15 mol % or less.

Note that the structural unit of the other nylon can reduce thermal-decomposability of the nylon resin described above. Thus, the nylon resin described above that is a copolymer with the structural unit of the other nylon can suppress contamination by a monomer generated by decomposition during melt processing (especially, a monomer that becomes as a raw material for the structural unit represented by Formula (1)). Thus, the nylon resin described above can suppress environmental pollution due to elution of a decomposed monomer from a molded body.

The type and the proportion of each of the structural units contained in the nylon resin described above can be calculated based on an integrated value of a peak assigned to each structural unit present in a spectrum obtained by ¹H-NMR measurement or ¹³C-NMR measurement.

The nylon resin described above may be a random copolymer or a block copolymer; however, from the viewpoint of enhancing biodegradability, the nylon resin is preferably a random copolymer. The random copolymer can be distinguished by, for example, measurement of a melting point or glass transition temperature determined by differential scanning calorimeter (DSC), an infrared absorption spectrum (IR spectrum), or a spectrum obtained by ¹³C-NMR measurement.

According to the knowledge of the inventors of the present invention, the nylon resin having a higher degree of randomness of the structural unit exhibits better biodegradability. In other words, for each of the structural unit represented by Formula (1) and the structural unit of the other nylon, the more different structural units are connected side by side without forming a block where the same type of structural units are continuously present, the higher biodegradability is achieved. From the viewpoints described above, the nylon resin described above has a difference between a degree of randomness that is determined based on a proportion of each of structural units determined by ¹H-NMR measurement and that is based on the assumption that structural units are in an ideal random sequence (hereinafter, also referred to as “theoretical degree of ¹H randomness”) and a degree of randomness that is determined based on a proportion of carbonyl carbons of amide groups linking different structural units with respect to total peak intensity of carbonyl carbons determined by ¹³C-NMR measurement (hereinafter, also referred to as “degree of ¹³C randomness”) (hereinafter, also referred to as “difference Δ between degrees of randomness”) of preferably 0.10 or less, and more preferably 0.05 or less. The lower limit value of the difference Δ between degrees of randomness is not particularly limited and can be 0.00 or greater.

Note that degree of ¹³C randomness is a value calculated based on the following Expression 1.

(sum of peak integrated values originated from carbonyl carbon peaks of amide groups connected to the first monomer structural unit and the second monomer structural unit)/(sum of peak integrated values originated from all carbonyl carbon peaks) Expression 1:

The theoretical degree of ¹H randomness is a proportion of carbonyl carbons of amide groups linking different structural units with respect to total number of carbonyl carbons when all structural units are stochastically and randomly sampled and arranged in the nylon resin described above and is calculated by the following Expression 2 based on the proportion of each structural unit determined by ¹H-NMR measurement.

(abundance proportion of structural unit represented by Formula (1))×(abundance proportion of structural unit of other nylon)×2 Expression 2:

The difference Δ between degrees of randomness can be adjusted by catalyst type, polymerization temperature, and the like. For example, by using a Grignard reagent enhancing reactivity of a monomer as a catalyst, a difference between reactivities of monomers can be made small, and thus the difference Δ between degrees of randomness can be made small. Furthermore, when the polymerization temperature is a high temperature, the monomer that becomes the structural unit of the other nylon is preferentially consumed, or when the polymerization temperature is a low temperature, the monomer that becomes the NA4 structural unit is preferentially consumed, and thus a block in which the monomers are continuously present tends to be formed. Thus, by setting the polymerization temperature to an adequate range based on the combination of the monomers, the difference between reactivities of monomers is made small, and the difference Δ between degrees of randomness can be made small.

The nylon resin described above may be linear or branched. From the viewpoint of enhancing moldability and strength of the filament, the nylon resin described above is preferably linear. A linear nylon resin can be obtained by using a polymerization initiator with one branching or two branching at the time of polymerization described below.

From the viewpoint of providing biodegradability, heat resistance and strength in water of a molded product in a compatible manner, the melting point of the nylon resin described above is preferably 220 °C or lower, more preferably 160 °C or higher and 215 °C or lower, and even more preferably 180 °C or higher and 210 °C or lower. The melting point of the nylon resin can be measured by DSC. Note that, when the difference Δ between degrees of randomness is large (i.e., when a block of any of the structural units is formed), two or more melting points may be observed for the nylon resin by NMR; however, the nylon resin described above preferably has only one melting point observed by NMR.

Furthermore, the nylon resin described above can have a large temperature difference between the melting point and the thermal decomposition temperature by the second monomer structural unit constituting the other nylon structure. Since a homopolymer of nylon 4 has the melting point and the thermal decomposition temperature that are close each other, melt molding is difficult; however, the nylon described above can be easily melt-molded.

The weight average molecular weight (Mw) and the number average molecular weight (Mn) of the nylon resin described above are not particularly limited. For example, the Mw of the nylon resin described above may be 10000 or greater, 30000 or greater, or 50000 or greater. The Mw of the nylon resin described above may be 1000000 or less, 500000 or less, 300000 or less, 200000 or less, and 100000 or less. The Mw of the nylon resin described above can be determined by a known technology such as gel permeation chromatography (GPC), calibrated with a polymethyl methacrylate resin (PMMA).

The polydispersity (Mw/Mn) of the nylon resin described above is preferably 3.0 or less, more preferably 2.5 or less, and even more preferably 2.0 or less. The lower limit value of the Mw/Mn is not particularly limited and can be 1.0 or greater. Because a smaller Mw/Mn results in less oligomers that are low molecular weight substances, change in properties due to elution of the oligomers at the time of use and environmental pollution due to the eluted oligomers can be suppressed. Furthermore, a smaller Mw/Mn can enhance mechanical strength of the filament.

In a case where the nylon resin described above is a random copolymer, the nylon resin can be synthesized by subjecting a monomer that becomes the structural unit represented by Formula (1) (first monomer) and a monomer that becomes the structural unit of another nylon (second monomer) to ring-opening copolymerization in the presence of a basic catalyst and a polymerization initiator.

As the first monomer, glycine, α-alanine, β-alanine, β-lactam (2-azetidinone), and 2-pyrrolidone can be used. As the second monomer, a lactam compound having 5 or more and 12 or less carbons, such as δ-valerolactam (2-piperidone), ε-caprolactam, ω-octalactam, and ω-laurolactam, a salt of adipic acid and hexamethylenediamine, and the like can be used.

The basic catalyst is only required to be a compound that can generate an anion species in each of the monomers. Examples of the basic catalyst include Grignard reagents, such as ethylmagnesium bromide (EtMgBr), ethylmagnesium chloride (EtMgCl), butylmagnesium chloride (BuMgCl), methylmagnesium chloride (MeMgCl), and methylmagnesium iodide (MeMgl); alkali metals, such as lithium, sodium, and potassium, and hydrides, oxides, hydroxides, carbonates, carboxylates, alkylated bodies, and alkoxides of the alkali metals, and hydrides, oxides, hydroxides, carbonates, carboxylates, alkylated bodies, and alkoxides of alkaline earth metals, such as calcium. Examples of the alkylated body of the alkali metal include pyrrolidone potassium and tert-butoxy potassium. At this time, pyrrolidone potassium may be allowed to act as a monomer and a basic catalyst. Among these, from the viewpoints of being less likely to cause environmental pollution by residue because the required amount is small, being able to perform polymerization at a relatively low temperature, and easily achieving a smaller difference Δ between degrees of randomness, a Grignard reagent is preferred.

The used amount (added amount) of the basic catalyst is not particularly limited and is preferably 0.01 mol % or greater and 20 mol % or less, more preferably 0.03 mol % or greater and 15 mol % or less, and even more preferably 0.05 mol % or greater and 10 mol % or less, with respect to the total amount of the raw material monomers. Note that, when the Grignard reagent is used, from the viewpoint of achieving good balance of the reaction rate and cost of the catalyst, the used amount of the basic catalyst can be 0.05 mol % or greater and 5 mol % or less, 0.15 mol % or greater and 2.5 mol % or less, and 1 mol % or greater and 1.5 mol % or less, with respect to the total amount of the raw material monomers.

Furthermore, as a catalytic promoter, a quaternary ammonium salt such as tetramethylammonium chloride, a quaternary phosphonium salt such as tetrabutylphosphonium bromide, a crown ether, and the like may be used in combination. By using these in combination, effects such as reduction in the catalyst amount, reduction in the polymerization time, and enhancement in yield can be expected.

Examples of the polymerization initiator include an ester compound or a derivative thereof, an imide compound, and carbon dioxide. From the viewpoint of enhancing moldability of the nylon, an ester compound or a derivative thereof and an imide compound are preferred. The polymerization initiator may be a compound with one branching or may be a compound with two branching or three branching. From the viewpoint of providing improvement of processability at the time of molding and improvement of strength and toughness of the molded product, a compound with two branching is preferred, and a compound with one branching is particularly preferred. Examples of the polymerization initiator with one branching include tert-butyl acetate, isopropyl myristate, N-acetyl-ε-caprolactam, 1-acetyl-2-pyrrolidone, and N-benzoyl-2-pyrrolidone. Examples of the polymerization initiator having two branching or three branching include diisopropyl adipate and adipoyl dipyrrolidone.

The used amount (added amount) of the polymerization initiator is not particularly limited and is preferably 0.01 mol % or greater and 1.5 mol % or less, more preferably 0.03 mol % or greater and 1.0 mol % or less, even more preferably 0.05 mol % or greater and 0.75 mol % or less, and particularly preferably 0.2 mol % or greater and 0.3 mol % or less, with respect to the total amount of the raw material monomers. When the used amount of the polymerization initiator is in the range described above, a nylon resin that has a high molecular weight can be obtained.

The polymerization temperature can be, for example, 25 °C or higher and 250 °C or lower. In a case of a nylon 4/6 copolymer, from the viewpoint of making a difference between reactivities of monomers small and making the difference Δ between degrees of randomness smaller, the polymerization temperature is preferably 50 °C or higher and 180 °C or lower, and more preferably 80 °C or higher and lower than 150 °C.

Note that the synthesis method of the nylon resin described above is not limited to this and, for example, γ-aminobutyric acid (GABA) and a lactam compound having 5 or more and 12 or less carbons or w-amino carboxylic acid may be reacted.

### Filament

The filament can be produced by melt-extruding a resin composition containing the nylon resin described above and spinning to a monofilament.

Besides the nylon resin described above, the resin composition described above may contain a known additive, such as another resin, a plasticizer, a nucleating agent, an antioxidant, a UV absorber, a dye, a pigment, a heat stabilizer, a light stabilizer, a filler, an internal mold release agent, a matting agent, an electroconductivity imparting agent, a charge control agent, an antistatic agent, a lubricant, and other processing aids.

Note that, from the viewpoint of enhancing biodegradability of the filament, the resin composition described above has a proportion of the nylon resin described above of preferably 70 mass % or greater and 100 mass % or less, more preferably 90 mass % or greater and 100 mass % or less, and even more preferably 95 mass % or greater and 100 mass % or less, with respect to the total mass of the resin component.

The melt extrusion is preferably performed at a temperature that is higher than the melting point of the nylon resin described above but lower than the thermal decomposition temperature. At this time, use of a resin having a low melting point as the nylon resin described above increases a range of temperature at which melt extrusion can be performed and can facilitate molding. For example, the melt extrusion can be performed at 180 °C or higher and 270 °C or lower.

The resin composition melt-extruded in a fibrous form is preferably cooled by a water bath. The bath temperature at this time can be 0 °C or higher and 10 °C or lower.

The monofilament obtained as described above is appropriately stretched to obtain a filament. When the stretching ratio is not enough, adequate orientation cannot be achieved, and strength required for a fishing line cannot be achieved. The condition for the stretching treatment is not particularly limited, and the stretching ratio can be 4 times or greater and 7 times or less. From the viewpoint of improving knot strength, the stretching ratio is preferably 5 times or greater and 6 times or less. Note that the stretching may be performed in multiple steps. Furthermore, relaxation treatment may be performed after the stretching.

The diameter of the filament is not particularly limited. For example, the diameter of the filament can be 0.05 mm or greater and 4.0 mm or less.

The filament obtained as described above has high knot strength on land and in water and also has good biodegradability.

For example, the filament described above can have a knot strength measured at 25 °C and a relative humidity of 50% of 100 MPa or greater, and the knot strength is preferably 300 MPa or greater, and more preferably 600 MPa or greater. Furthermore, the filament described above can have a knot strength measured by, after the filament is knotted and immersed in pure water at 25 °C for 3 hours, taking out the filament from the pure water and performing a measurement at 25 °C without drying the filament of 100 MPa or greater, and the knot strength is preferably 300 MPa or greater, and more preferably 500 MPa or greater. Furthermore, the filament described above can have a knot strength measured by, after the filament is knotted and immersed in sea water at 25 °C for 3 hours, taking out the filament from the sea water and performing a measurement at 25 °C without drying the filament of 100 MPa or greater, and the knot strength is preferably 300 MPa or greater, and more preferably 500 MPa or greater. The upper limits of these knot strengths are not particularly limited and can be 1000 MPa or less.

Note that the knot strength described above is a value obtained by using a 300 mm long filament having a half knot part at the center in the longitudinal direction as a test sample, setting a gripping distance to 150 mm and a crosshead speed of a test machine to 150 mm/min, and dividing a strength obtained at the break of the knot part by the diameter of the filament.

The sea water used in the measurement described above is required to have a NaCl concentration of 3% or greater and 4% or less. The sea water used in the measurement described above may be sea water actually sampled from the sea or may be a commercially available artificial sea water, such as MARINE ART (trade name) SF-1, available from Osaka Yakken Co., Ltd.

Furthermore, after knotted, the filament described above has a reduction percentage of a knot strength measured at 25 °C and a relative humidity of 50% after the filament is knotted, then stored in an interface between sea water and sediment at 25 °C for 1 month, washed with water, and then dried, with respect to a knot strength measured in the same conditions before the storage of preferably 10% or greater, more preferably 20% or greater, and even more preferably 30% or greater. Meanwhile, from the viewpoint of suppressing reduction in strength during use of the filament in sea water, the reduction percentage described above is preferably 80% or less, more preferably 70% or less, and even more preferably 60% or less.

Note that the interface between the sea water and the sediment described above means an environment that is stipulated in ISO 19679 and that is within 5 cm from the interface between the sea water and the sediment. The sediment described above can be sea sand sampled from the sea.

### Filament for Fishery Material

The filament described above can be used as a filament for a fishery material, such as a fishing line or a fishing net. The filament for a fishery material including the filament described above has both biodegradability and adequate knot strength in water.

### Other Embodiments

Note that the above-described embodiment is an exemplary embodiment of the present invention, and it is needless to say that the present invention can include embodiments other than the above-described embodiment within the scope of the core technical idea thereof.

### EXAMPLES

The present invention will be described in detail below based on examples, but the present invention is not limited to these examples.

### 1. Preparation of Filament

Polymers 1 to 9 and polymers 11 to 13 were synthesized by the following method. Using these and a polymer 10, filament 1 to filament 13 were prepared by the following method.

### 1-1. Preparation of Filament 1

243.8 g (2.86 mol) of 2-pyrrolidone, available from Mitsubishi Chemical Corporation, and 756.2 g (6.68 mol) of ε-caprolactam, available from Tokyo Chemical Industry Co., Ltd., were prepared, mixed, and heated and melted at 80 °C, and thus a uniform monomer solution was prepared. This monomer solution was divided into two. In one of the monomer solutions, 8.03 g (0.30 mol % with respect to the total moles of the 2-pyrrolidone and the &-caprolactam) of adipoyl dipyrrolidone separately synthesized was added and dissolved, and thus an initiator solution was obtained. In the other monomer solution, 143.2 mL (1.5 mol % of ethylmagnesium bromide (EtMgBr) with respect to the total moles of the 2-pyrrolidone and the ε-caprolactam) of a tetrahydrofuran solution of EtMgBr, available from Tokyo Chemical Industry Co., Ltd., (approximately 1 mol/L) was added dropwise, then tetrahydrofuran was distilled off and removed under reduced pressure, and thus a catalyst solution was obtained. The initiator solution and the catalyst solution were mixed and polymerization-reacted at 100 °C, and thus a polymer 1 was obtained.

After the polymer was crushed, the polymer was washed with pure water, an acetic acid aqueous solution, pure water, and pure water in this order, and unreacted monomers and the catalyst were removed. Thereafter, water was removed by drying under reduced pressure, and thus a polymer powder for spinning was obtained.

The obtained polymer powder described above was fed to a small twin-screw extruder, melt-extruded into a fibrous form, and cooled and solidified by passing through a cold bath, and thus an unstretched monofilament was produced. This monofilament was appropriately stretched, and thus a filament 1 was obtained.

### 1-2. Preparation of Filament 2

A polymer 2 was obtained in the same manner as in the synthesis of the polymer 1 except for changing the raw materials of the polymer to 1.38 mol of 2-pyrrolidone and 7.80 mol of ε-caprolactam. Using this polymer 2, a monofilament was prepared in the same manner as in preparation of the filament 1. The monofilament was then stretched, and thus a filament 2 was prepared.

### 1-3. Preparation of Filament 3

A polymer 3 was obtained in the same manner as in the synthesis of the polymer 1 except for changing the raw materials of the polymer to 1.86 mol of 2-pyrrolidone and 7.44 mol of ε-caprolactam, and blending 0.30 mol % of isopropyl myristate with respect to the total moles of the 2-pyrrolidone and the ε-caprolactam in place of the adipoyl dipyrrolidone as the initiator. Using this polymer 3, a monofilament was prepared in the same manner as in preparation of the filament 1. The monofilament was then stretched, and thus a filament 3 was prepared.

### 1-4. Preparation of Filament 4

A polymer 4 was obtained in the same manner as in the synthesis of the polymer 1 except for changing the raw materials of the polymer to 4.03 mol of 2-pyrrolidone and 4.03 mol of ε-caprolactam, blending 0.20 mol % of N-acetyl-ε-caprolactam with respect to the total moles of the 2-pyrrolidone and the ε-caprolactam in place of the adipoyl dipyrrolidone as the initiator blended in the initiator solution, changing the blended amount of the EtMgBr blended in the catalyst solution to 1.0 mol % with respect to the total moles of the 2-pyrrolidone and the ε-caprolactam, and changing the temperature of the polymerization reaction to 60 °C. Using this polymer 4, a monofilament was prepared in the same manner as in preparation of the filament 1. The monofilament was then stretched, and thus a filament 4 was prepared.

### 1-5. Preparation of Filament 5

A polymer 5 was obtained in the same manner as in the synthesis of the polymer 1 except for changing the raw materials of the polymer to 4.03 mol of 2-pyrrolidone and 4.03 mol of ε-caprolactam, blending 0.20 mol % of N-acetyl-8-caprolactam with respect to the total moles of the 2-pyrrolidone and the ε-caprolactam in place of the adipoyl dipyrrolidone as the initiator blended in the initiator solution, changing the blended amount of the EtMgBr blended in the catalyst solution to 1.0 mol % with respect to the total moles of the 2-pyrrolidone and the ε-caprolactam, and changing the temperature of the polymerization reaction to 50 °C. Using this polymer 5, a monofilament was prepared in the same manner as in preparation of the filament 1. The monofilament was then stretched, and thus a filament 5 was prepared.

### 1-6. Preparation of Filament 6

A polymer 6 was obtained in the same manner as in the synthesis of the polymer 1 except for changing the raw materials of the polymer to 24.67 mol of 2-pyrrolidone and 10.58 mol of ε-caprolactam, changing the amount of the adipoyl dipyrrolidone blended in the initiator solution to 0.25 mol % with respect to the total moles of the 2-pyrrolidone and the ε-caprolactam, blending 5.0 mol % each of tert-butoxy potassium (tBuOK) and tetramethylammonium chloride (TMAC) with respect to the total moles of the 2-pyrrolidone and the ε-caprolactam in place of the EtMgBr as the catalyst blended in the catalyst solution, and changing the temperature of the polymerization reaction to 50 °C. Using this polymer 6, a monofilament was prepared in the same manner as in preparation of the filament 1. The monofilament was then stretched, and thus a filament 6 was prepared.

### 1-7. Preparation of Filament 7

A polymer 7 was obtained in the same manner as in the synthesis of the polymer 6 except for changing the raw materials of the polymer to 8.34 mol of 2-pyrrolidone and 3.41 mol of ε-caprolactam, and blending 0.20 mol % of tert-butyl acetate with respect to the total moles of the 2-pyrrolidone and the ε-caprolactam in place of the adipoyl dipyrrolidone as the initiator blended in the initiator solution. Using this polymer 7, a monofilament was prepared in the same manner as in preparation of the filament 1. The monofilament was then stretched, and thus a filament 7 was prepared.

### 1-8. Preparation of Filament 8

A polymer 8 was obtained in the same manner as in the synthesis of the polymer 6 except for changing the raw materials of the polymer to 9.05 mol of 2-pyrrolidone and 2.70 mol of ε-caprolactam, and blending 0.20 mol % of tert-butyl acetate with respect to the total moles of the 2-pyrrolidone and the ε-caprolactam in place of the adipoyl dipyrrolidone as the initiator blended in the initiator solution. Using this polymer 8, a monofilament was prepared in the same manner as in preparation of the filament 1. The monofilament was then stretched, and thus a filament 8 was prepared.

### 1-9. Preparation of Filament 9

A polymer 9 was obtained in the same manner as in the synthesis of the polymer 6 except for changing the raw materials of the polymer to 141.00 mol of 2-pyrrolidone and 0.00 mol of ε-caprolactam, blending 0.10 mol % of tert-butyl acetate with respect to the total moles of the 2-pyrrolidone and the ε-caprolactam in place of the adipoyl dipyrrolidone as the initiator blended in the initiator solution, blending 2.0 mol % each of tert-butoxy potassium (tBuOK) and tetramethylammonium chloride (TMAC) with respect to the total moles of the 2-pyrrolidone and the ε-caprolactam in place of the EtMgBr as the catalyst blended in the catalyst solution, and changing the temperature of the polymerization reaction to 25 °C. Using this polymer 9, a monofilament was prepared in the same manner as in preparation of the filament 1. The monofilament was then stretched, and thus a filament 9 was prepared.

### 1-10. Preparation of Filament 10

A commercially available nylon 6 resin (UBE nylon 1022B, available from Ube Industries, Ltd.) was used as a polymer 10. This polymer 10 was pulverized to obtain a polymer powder for spinning. Using the obtained polymer powder described above, a monofilament was prepared in the same manner as in the preparation of the filament 1. This monofilament was appropriately stretched, and thus a filament 10 was obtained.

### 1-11. Preparation of Filament 11

A polymer 11 was obtained in the same manner as in the synthesis of the polymer 1 except for changing the raw materials of the polymer to 0.95 mol of 2-pyrrolidone and 1.93 mol of ε-caprolactam. Using this polymer 11, a monofilament was prepared in the same manner as in preparation of the filament 1. The monofilament was then stretched, and thus a filament 11 was prepared.

### 1-12. Preparation of Filament 12

A polymer 12 was obtained in the same manner as in the synthesis of the polymer 1 except for changing the raw materials of the polymer to 1.24 mol of 2-pyrrolidone and 1.72 mol of ε-caprolactam. Using this polymer 12, a monofilament was prepared in the same manner as in preparation of the filament 1. The monofilament was then stretched, and thus a filament 12 was prepared.

### 1-13. Preparation of Filament 13

0.95 mol of 2-pyrrolidone, available from Mitsubishi Chemical Corporation, 1.77 mol of ε-caprolactam, available from Tokyo Chemical Industry Co., Ltd., and 0.35 mol of 12-aminododecanoic acid, available from Tokyo Chemical Industry Co., Ltd., were prepared and mixed in an autoclave, and the temperature was increased to 250 °C in the sealed environment. After completion of the temperature elevation to 250 °C, a pressure release valve of the autoclave was opened to set the pressure to atmospheric pressure, then the valve was closed again, polymerization reaction was performed at 250 °C, and thus a polymer 13 was obtained. Using this polymer 13, a monofilament was prepared in the same manner as in preparation of the filament 1. The monofilament was then stretched, and thus a filament 13 was prepared.

The polymerization conditions for the polymer 1 to the polymer 13 used in the production of the filament 1 to the filament 13 are listed in Table 1. Note that, regarding the type of the polymer, “NA4/6” refers to nylon 4/6, “NA4” refers to nylon 4, and “NA6” refers to nylon 6. The added amounts of 5 the initiator and the catalyst are blended amounts with respect to the total moles of the monomers, “pyrrolidone” in the monomer refers to the amount of 2-pyrrolidone, and “caprolactam” refers to the amount of ε-caprolactam.

TABLE 1

| | | Initiator | | Catalyst | | Monomer |
|---|---|---|---|---|---|---|
| Polymer | | | Added amount | | Added amount | Pyrrolidone |
| No. | Type | Type | (mol %) | Type | (mol %) | (mol) |
| 1 | NA4/6 | Adipoyl dipyrrolidone | 0.30 | EtMgBr | 1.5 | 2.86 |
| | | (two branching) | | | | |
| 2 | NA4/6 | Adipoyl dipyrrolidone | 0.30 | EtMgBr | 1.5 | 1.38 |
| | | (two branching) | | | | |
| 3 | NA4/6 | Isopropyl myristate | 0.30 | EtMgBr | 1.5 | 1.86 |
| | | (one branching) | | | | |
| 4 | NA4/6 | Acetylcaprolactam | 0.20 | EtMgBr | 1.0 | 4.03 |
| | | (one branching) | | | | |
| 5 | NA4/6 | Acetylcaprolactam | 0.20 | EtMgBr | 1.0 | 4.03 |
| | | (one branching) | | | | |
| 6 | NA4/6 | Adipoyl dipyrrolidone | 0.25 | tBuOK | 5.0 | 24.67 |
| | | (two branching) | | TMAC | 5.0 | |
| 7 | NA4/6 | tert-Butyl acetate | 0.20 | tBuOK | 5.0 | 8.34 |
| | | (one branching) | | TMAC | 5.0 | |
| 8 | NA4/6 | tert-Butyl acetate | 0.20 | tBuOK | 5.0 | 9.05 |
| | | (one branching) | | TMAC | 5.0 | |
| 9 | NA4 | tert-Butyl acetate | 0.10 | tBuOK | 2.0 | 141.00 |
| | | (one branching) | | TMAC | 2.0 | |
| 10 | NA6 | — | — | — | — | — |
| 11 | NA4/6 | Adipoyl dipyrrolidone | 0.30 | EtMgBr | 1.5 | 0.95 |
| | | (two branching) | | | | |
| 12 | NA4/6 | Adipoyl dipyrrolidone | 0.30 | EtMgBr | 1.5 | 1.24 |
| | | (two branching) | | | | |
| 13 | NA4/6/12 | — | — | — | — | 0.95 |

| | Monomer | | | |
|---|---|---|---|---|
| Polymer | Caprolactam | 12-Aminododecanoic acid | Polymerization temperature | |
| No. | (mol) | (mol) | (°C) | Stretching ratio |
| 1 | 6.68 | — | 100 | 6 |
| 2 | 7.80 | — | 100 | 5.5 |
| 3 | 7.44 | — | 100 | 5.5 |
| 4 | 4.03 | — | 60 | 6 |
| 5 | 4.03 | — | 50 | 6 |
| 6 | 10.58 | — | 50 | 6.5 |
| 7 | 3.41 | — | 50 | 6.5 |
| 8 | 2.70 | — | 50 | 5 |
| 9 | — | — | 25 | 4.5 |
| 10 | — | — | — | 5.4 |
| 11 | 1.93 | — | 100 | 5.5 |
| 12 | 1.72 | — | 100 | 5.5 |
| 13 | 1.77 | 0.35 | 250 | 5.5 |

### 2. Measurement

For the polymer 1 to the polymer 13, measurement using ¹H-NMR, ¹³C-NMR, DSC, and TGA, and biodegradability (based on O₂) test were performed by the following methods. GPC analysis was performed for the filament 1 to the filament 13 by the following method.

### 2-1. ¹H-NMR Measurement

¹H-NMR spectrum was obtained by using a nuclear magnetic resonance spectrometer (JNM-ECZ600R/S1, available from JASCO Corporation). were compared. Specifically, 10 mg of a sample of each of the polymers was dissolved in 1 mL of a mixed solvent having a volume ratio of trifluoroethanol (TFE)/deuterated chloroform (CDCl₃) of 1/1. Then, measurement was performed using tetramethylsilane (TMS) as a reference. Among peaks originated from methylene groups appearing from 1.0 ppm to 2.0 ppm in the obtained spectrum, a ratio of an integrated value of a peak of methylene proton originated from the nylon 4 structural unit and an integrated value of a peak of methylene proton originated from the nylon 6 unit was determined. From the integrated value ratio of these peaks, the proportion of the nylon 4 structural unit was calculated and this was used as “NA4 proportion”.

Furthermore, based on this NA4 proportion and the proportion of the nylon 6 structural unit (NA6 proportion) calculated simultaneously, the degree of randomness ((NA4 proportion)×(NA6 proportion)×2) assuming that each of the polymers had an ideal random sequence of the nylon 4 structural unit and the nylon 6 structural unit was calculated, and this was used as “theoretical degree of ¹H randomness”.

### 2-2. ¹³C-NMR Measurement

¹³C-NMR spectrum was obtained by using a nuclear magnetic resonance spectrometer (JNM-ECZ600R/S1, available from JASCO Corporation). Specifically, 10 mg of a sample of each of the polymers was dissolved in 1 ml of a mixed solvent having a volume ratio of trifluoroethanol (TFE)/deuterated chloroform (CDCl₃) of 1/1. Then, measurement was performed using tetramethylsilane (TMS) as a reference. The proportion of peak intensity of carbonyl carbon of an amide group linking the nylon 4 structural unit and the nylon 6 structural unit with respect to the total of all peak intensities originated from carbonyl carbons appearing from 174 ppm to 177 ppm in the obtained spectrum was calculated, and this was used as “degree of ¹³C randomness”.

### 2-3. DSC Measurement

A DSC curve was obtained by the differential scanning calorimetry method (DSC method) using a differential scanning calorimeter (DSC3⁺, available from Mettler-Toledo). Specifically, 10 mg of a sample of each of the polymers was weighed in an aluminum pan, and the temperature was increased at a rate of 20 °C/minute in a range of 25 °C to 280 °C in a nitrogen atmosphere, and thus a DSC curve was obtained. A peak temperature of an endothermic peak of melting behavior in this DSC curve was used as “melting point” of each of the polymers.

### 2-4. TGA Measurement

A thermogravimetric reduction curve was obtained by using a simultaneous thermogravimetry-differential scanning calorimeter (TGA/DSC 2, available from Mettler-Toledo). Specifically, 10 mg of a sample of each of the polymers was weighed in an aluminum pan, and the temperature was increased at a rate of 20 °C/minute in a range of 25 °C to 500 °C in a nitrogen atmosphere, and thus a thermogravimetric reduction curve was obtained. The temperature at which weight was reduced by 5% in this thermogravimetric reduction curve was used as “5% thermogravimetric reduction temperature” of each of the polymers.

### 2-5. GPC Analysis

GPC analysis was performed by using a gel permeation chromatography (GPC) analysis device (HLC-8420GPC, available from Tosoh Corporation).

Specifically, 10 mg of a sample of each of the filaments was dissolved in hexafluoroisopropanol (HFIP), in which sodium trifluoroacetate had been dissolved at a concentration of 5 mM, to prepare 10 ml of a solution. The solution was then filtered using a membrane filter, and thus a sample solution was obtained. In the analysis device, 100 μL of this sample solution was injected, and measurement was performed in the following conditions. From the chromatogram obtained by the measurement, the weight average molecular weight (Mw) and the number average molecular weight (Mn) of the polymer constituting each of the filaments were calculated using a calibration curve obtained by a poly(methyl methacrylate) resin (PMMA) having a known molecular weight.
Instrument: HLC-8420 GPC, available from Tosoh Corporation.
Column: HFIP 806M×2 in series, 40 °C.
Eluent: 5 mM CF₃COONa/HFIP
Flow rate: 1.0 mL/min
Detector: Differential refractometer (RI)

### 2-6. Biodegradability (Based on O₂)

In 4000 mL of sea water sampled from Pacific Ocean coastline, 2000 g of sediment sampled similarly from Pacific Ocean coastline was added and subjected to an ultrasonic treatment to extract microorganisms from the sediment into the sea water. In the extracted sea water, 0.5 g/L of ammonium chloride and 0.1 g/L of potassium dihydrogenphosphate as nutritive salts were dissolved and then subjected to an aeration treatment, and thus extracted sea water was prepared. In 300 ml of the prepared extracted sea water, approximately 40 mg of the polymer powder was dispersed. The pressure change caused by allowing sodium hydroxide to capture generated carbon dioxide in a tightly sealed environment was measured for 4 weeks using a BOD meter (OxiTop i, available from WTW). The biodegradability of the polymer powder was evaluated based on the following equation using the oxygen amount required in a case where the polymer was 100% decomposed as a theoretical value.

Biodegradability (%)=(amount of oxygen consumption originated from sample/theoretical amount of oxygen requirement)×100

In Table 2 and Table 3, the NA4 proportion, the theoretical degree of ¹H randomness, the degree of ¹³C randomness, the difference Δ between the theoretical degree of ¹H randomness and the degree of ¹³C randomness, the melting point, the 5% thermogravimetric reduction temperature, the difference ΔT between the melting point and the 5% thermogravimetric reduction temperature, the weight average molecular weight Mw, the number average molecular weight Mn, the Mw/Mn, the NA4 proportion of each of the polymers in terms of mass calculated based on the molar ratio of the NA4, the biodegradability evaluated based on O₂, and the stretching ratio of the polymer 1 to the polymer 13 and the filament 1 to the filament 13 are listed.

TABLE 2

| Polymer No./ | NA4 proportion | Theoretical degree | Degree of ¹³C | Difference Δ between |
|---|---|---|---|---|
| Filament No. | (mol %) | of ¹H randomness | randomness | degrees of randomness |
| 1 | 13 | 0.23 | 0.22 | 0.01 |
| 2 | 7 | 0.13 | 0.10 | 0.03 |
| 3 | 10 | 0.18 | 0.12 | 0.06 |
| 4 | 33 | 0.44 | 0.44 | 0.00 |
| 5 | 39 | 0.48 | 0.48 | 0.00 |
| 6 | 71 | 0.41 | 0.51 | 0.10 |
| 7 | 80 | 0.32 | 0.38 | 0.06 |
| 8 | 90 | 0.18 | 0.16 | 0.02 |
| 9 | 100 | 0.00 | 0.00 | 0.00 |
| 10 | 0 | 0.00 | 0.00 | 0.00 |
| 11 | 15 | 0.26 | 0.26 | 0.00 |
| 12 | 20 | 0.32 | 0.32 | 0.00 |
| 13 | 4 | 0.11 | 0.09 | 0.02 |

TABLE 3

| | Filament No. | | | | | | | |
|---|---|---|---|---|---|---|---|---|
| | | 5% Weight | | | | | NA4 | |
| | Melting point | reduction | ΔT | Mw | Mn | | proportion | Biodegradability |
| Polymer No. | (°C) | temperature | (°C) | (10⁴ g/mol) | (10⁴ g/mol) | Mw/Mn | (wt %) | (based on O₂) |
| 1 | 197 | 362 | 165 | 5.8 | 3.6 | 1.6 | 10 | 71 |
| 2 | 206 | 395 | 189 | 5.9 | 3.0 | 2.0 | 5 | 25 |
| 3 | 206 | — | — | 3.8 | 1.9 | 2.0 | 8 | >95 |
| 4 | 170 | — | — | 6.7 | 3.6 | 1.9 | 27 | >95 |
| 5 | 163 | — | — | 9.3 | 4.7 | 2.0 | 32 | >95 |
| 6 | 186 | — | — | 6.2 | 3.8 | 1.6 | 65 | — |
| 7 | 222 | — | — | 5.2 | 3.5 | 1.5 | 75 | — |
| 8 | 241 | — | — | 3.7 | 2.3 | 1.3 | 87 | — |
| 9 | 265 | 306 | 41 | 11.8 | 7.0 | 1.7 | 100 | >95 |
| 10 | 225 | 422 | 197 | 6.1 | 3.6 | 1.7 | 0 | <1 |
| 11 | 195 | — | — | 6.5 | 3.8 | 1.7 | 12 | >95 |
| 12 | 185 | — | — | 5.0 | 3.2 | 1.6 | 16 | >95 |
| 13 | 208 | — | — | 4.4 | 2.9 | 1.5 | 3 | 34 |

### 3. Evaluation

### 3-1. Strength

Knot strength of each of the filament 1 to the filament 13 in an indoor environment, an underwater environment, and a biodegradable environment was measured by the following method.

The knot strength was measured in an indoor environment, an underwater environment, and a biodegradable environment using a tensile test machine (TENSILON RTF-1210, available from A&D Company, Limited). Specifically, the knot strength in each environment was a value obtained by using each of the 300 mm long filaments (gripping distance) having a half knot part at the center in the longitudinal direction as a test sample, setting a crosshead speed of the test machine to 150 mm/min, and dividing a load at the break of the knot part by the diameter of the filament.

The conditions of the environment are as follows.
Indoor environment: Measured at 25 °C and a relative humidity of 50%
Underwater environment: Immersed in pure water at 25 °C for 3 hours, then knotted without drying, and then measured at 25 °C.
Biodegradable environment: Knotted, then stored at an interface between sea water and sediment at 25 °C for 1 month, and then measured at 25 °C and a relative humidity of 50%
Note that, as the sea water and the sediment, sea water sampled from Pacific Ocean coastline (NaCl concentration: 3.1 to 3.4%) and sea sand were respectively used.

Furthermore, the difference between the knot strength in the indoor environment and the knot strength in the biodegradable environment was calculated. Then, the proportion of this difference with respect to the knot strength in the indoor environment ((knot strength in indoor environment-knot strength in biodegradable environment)/knot strength in indoor environment×100) was determined and used as “reduction percentage of strength after biodegradation”. A case where the reduction percentage of strength in the biodegradable environment was 10% or greater was judged as having “biodegradability (based on strength)”.

The evaluation results of the knot strength in each of the indoor environment, the underwater environment, and the biodegradable environment, the reduction percentage of strength after biodegradation, and the biodegradability of the filament 1 to the filament 13 are listed in Table 4. Note that the filament 6 to the filament 8 became remarkably brittle in water, and the shapes as fishing lines could not be maintained. Thus, the knot strengths in the underwater environment and the biodegradable environment could not be measured.

### 3-2. First Monomer Content

Approximately 100 mg of a sample was dissolved in 10 ml of HFIP, and then acetone was added to attain 50 ml of a liquid. Thereafter, a filtrate obtained by removing the precipitated polymer by a 20-μm membrane filter was measured.
Measurement instrument: GC-2010 Plus, available from Shimadzu Corporation
Column: Rix 15 MS (0.25 mm φ-15 m-0.25 μm df), available from RESTEK Column temperature: 50 °C-5 min→(20 °C/min)→250 °C.
Vaporization chamber temperature: 250 °C.
Detector: FID
Split ratio: 50
Injection amount: 1 μL
Make up gas: He
Gas flow rate: 30 mL/min

The evaluation results of the knot strength in each of the indoor environment, the underwater environment, and the biodegradable environment, the reduction percentage of strength after biodegradation, and the biodegradability evaluated based on the reduction percentage of strength, and the content of 2-pyrrolidone of the filament 1 to the filament 13 are listed in Table 4.

TABLE 4

| | | | | | Reduction | | |
|---|---|---|---|---|---|---|---|
| | | | | | percentage of | | 2- |
| | | Knot strength (MPa) | | | strength after | | Pyrrolidone |
| | Filament | Indoor | Underwater | Biodegradable | biodegradation | Biodegradability | content |
| Notes | No. | environment | environment | environment | (%) | (based on strength) | (wt %) |
| Examples | 1 | 791 | 598 | 363 | 54 | Yes | Not |
| | | | | | | | detected |
| Examples | 2 | 672 | 651 | 324 | 52 | Yes | Not |
| | | | | | | | detected |
| Examples | 3 | 577 | 418 | 340 | 41 | Yes | Not |
| | | | | | | | detected |
| Examples | 4 | 659 | 181 | 260 | 61 | Yes | Not |
| | | | | | | | detected |
| Examples | 5 | 599 | 153 | 176 | 71 | Yes | Not |
| | | | | | | | detected |
| Comparative | 6 | 267 | Unmeasurable | Unmeasurable | Unmeasurable | Unmeasurable | Not |
| Examples | | | | | | | detected |
| Comparative | 7 | 539 | Unmeasurable | Unmeasurable | Unmeasurable | Unmeasurable | Not |
| Examples | | | | | | | detected |
| Comparative | 8 | 255 | Unmeasurable | Unmeasurable | Unmeasurable | Unmeasurable | Not |
| Examples | | | | | | | detected |
| Comparative | 9 | 700 | 461 | 187 | 73 | Yes | 3.8 |
| Examples | | | | | | | |
| Comparative | 10 | 595 | 591 | 545 | 8 | No | Not |
| Examples | | | | | | | detected |
| Examples | 11 | 538 | 390 | 370 | 31 | Yes | Not |
| | | | | | | | detected |
| Examples | 12 | 522 | 309 | 317 | 41 | Yes | Not |
| | | | | | | | detected |
| Examples | 13 | 418 | 344 | 389 | 7 | No | Not |
| | | | | | | | detected |

As is clear from Table 1 to Table 4, the filament 1 to the filament 5 that used the polymer 1 to the polymer 5 each being a nylon resin having the structural unit represented by Formula (1) and the structural unit of another nylon and having the proportion of the structural unit represented by the following Formula (1) with respect to all structural units of 1 mol % or greater and less than 40 mol % as well as the filament 11 to the filament 13 had biodegradability and experienced less embrittlement in water, and thus were able to be satisfactorily used as fishing lines and fishing nets. In addition, the filament 1 to the filament 5 and the filament 11 to the filament 13 each had comparable strength as that of nylon 6 (the filament 10) that has been typically used in fishing lines.

This application claims priority from the Japanese Patent Application No. 2022-158909 filed on Sep. 30, 2022, and the Japanese Patent Application No. 2023-074576 filed on Apr. 28, 2023. The original specification of the application, and the matters described in the claims are hereby incorporated by reference into the present application.

### INDUSTRIAL APPLICABILITY

The filament for a fishery material related to the present invention has adequate knot strength even in water and also has biodegradability. The present invention is thus expected to contribute to reduction in environmental pollution due to cut fishing lines.

1. A filament for a fishery material, comprising:
a filament containing a nylon resin comprising a structural unit represented by Formula (1) and a structural unit of another nylon,
wherein the nylon resin has a proportion of the structural unit represented by Formula (1) with respect to all structural units of 1 mol % or greater and less than 40 mol %, 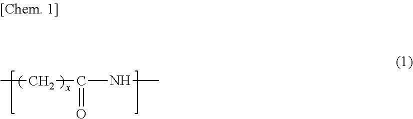
where in Formula (1), x is an integer of 3.

2. The filament for a fishery material according to claim 1, wherein
the nylon resin is a random copolymer in which the structural unit represented by Formula (1) and the structural unit of the other nylon are randomly arranged.

3. (canceled)

4. The filament for a fishery material according to claim 1, wherein
the structural unit of the other nylon include a nylon 6 structural unit, a nylon 12 structural unit, or a nylon 66 structural unit.

5. The filament for a fishery material according to claim 1, wherein
a knot strength measured at 25 °C and a relative humidity of 50% is 300 MPa or greater.

6. The filament for a fishery material according to claim 1, wherein
a knot strength measured after the filament is immersed in pure water at 25 °C for 3 hours, then taken out from the pure water, and knotted at 25 °C without drying is 100 MPa or greater.

7. The filament for a fishery material according to claim 1, wherein
a reduction percentage of a knot strength measured at 25 °C and a relative humidity of 50% after the filament is stored in an interface between sea water and sediment at 25 °C for 1 month and washed with water then dried, with respect to a knot strength measured in the same conditions before the storage, is 10% or greater.

8. The filament for a fishery material according to claim 1, which is a fishing line.

9. The filament for a fishery material according to claim 1, which is a fishing net.
